(19) United States
(12) Patent Application Publication
(10) Pub. No.: US 2022/0000194 A1
(43) Pub. Date: Jan. 6, 2022

(54) ONE-PIECE PERSONAL WEAR AND METHOD FOR FABRICATING THE SAME

(71) Applicant: Mackent Group Co., Ltd., Taoyuan City (TW)

(72) Inventor: Yi-Chen Lin, Taoyuan City (TW)

(21) Appl. No.: 17/365,535

(22) Filed: Jul. 1, 2021

(30) Foreign Application Priority Data
Jul. 3, 2020 (TW) 109122674

(51) Int. Cl. A41D 13/05; A41D 31/102; A41D 31/30

(52) U.S. Cl. CPC A41D 13/05; A41D 2500/10; A41D 31/305; A41D 31/102

(57) ABSTRACT

One-piece personal wear and a method for fabricating the same are provided. The one-piece personal wear includes a first fabric layer with a first contour and a second fabric layer with a second contour. One or more joint areas are arranged at the predetermined edges of the first contour and the second contour. An intermediate fabric layer is locally provided to intertwine with portions of the first fabric layer and the second fabric layer within the joint area range to form a three-layer fabric structure. The three-layer fabric structure is formed before the first fabric and second layers are tailored out along the first contour and the second contour.

### CROSS-REFERENCE TO RELATED APPLICATION

This non-provisional application claims priority under 35 U.S.C. § 119(a) to Invention Patent Application No. 109122674 filed in Taiwan, R.O.C. on Jul. 3, 2020, the entire contents of which are hereby incorporated by reference.

### BACKGROUND

### Technical Field

The instant disclosure generally relates to personal wears manufactured employing novel knitted textile fabrics, especially to one-piece personal wear and a method for fabricating the one-piece personal wear.

### Related Art

The traditional method of manufacturing personal wear generally requires patterned separately for the front-side fabric and the back-side fabric and stitched them together. A step of tailoring the wear is after that followed. However, wearers often feel uncomfortable with the gap between the front-side and back-side fabrics. The air permeability of the stitches is lacking, which results in discomfort to the wearers.

As a result, the inventor and applicant of the instant disclosure think about reducing or eliminating the uncomfortable feedback from the users, usually the wears, and enhancing its breathability at the same time. Therefore, the improvement of the manufacturing personal wear technology is needed.

### SUMMARY

For the reason above, it is an objective of the instant disclosure to introduce one-piece personal wear and a method for fabricating the same to eliminate the drawbacks encountered in the traditional technology that cause the wearers uncomfortable through using the one-piece and three-dimensional designs.

It is also another objective to provide the one-piece personal wear and the method for fabricating the same. Three-dimensional fabricating technology is employed for forming a sandwich structure design to enhance the air permeability compared with the traditional stitches. The personal wear in accordance with the instant disclosure would be provided with the several features being softer, more comfortable, more breathable, and splash-proof.

The instant disclosure provides one-piece personal wear that comprises a first fabric layer with a first contour and a second fabric layer with a second contour to achieve the objectives above. At least one joint area is arranged at predetermined edges of the first contour and the second contour. Besides, an intermediate fabric layer is locally provided to intertwine with the first fabric layer and the second fabric layer within at least one joint area to form a three-layer fabric structure.

Moreover, the instant disclosure presents a method for fabricating one-piece personal wear, comprising the following steps of forming a first fabric layer and a second fabric layer provided with a first contour and a second contour, respectively, under a specification of the one-piece personal wear; and forming at least one joint area arranged at predetermined edges of the first contour and the second contour; forming an intermediate fabric layer locally intertwining with the first fabric layer and the second fabric layer within the at least one joint area to form a three-layer fabric structure.

### BRIEF DESCRIPTION OF THE DRAWINGS

The disclosure will become more fully understood from the detailed description given hereinbelow for illustration only, and thus not a limitation of the disclosure, wherein:

FIG. 1 is the floor plan view of the first preferred embodiment in accordance with the instant disclosure;

FIG. 2 is a locally partial perspective view of the area 2 enlarged from the FIG. 1;

FIG. 3 is a floor plan view of the second preferred embodiment in accordance with the instant disclosure;

FIG. 4 is an expanded perspective view of FIG. 3;

FIG. 5 a floor plan of the third preferred embodiment in accordance with the instant disclosure;

FIG. 6 is a locally partial view of the area 6 enlarged from the FIG. 5; and

FIG. 7 is a schematic diagram of an arrangement board.

### DETAILED DESCRIPTION

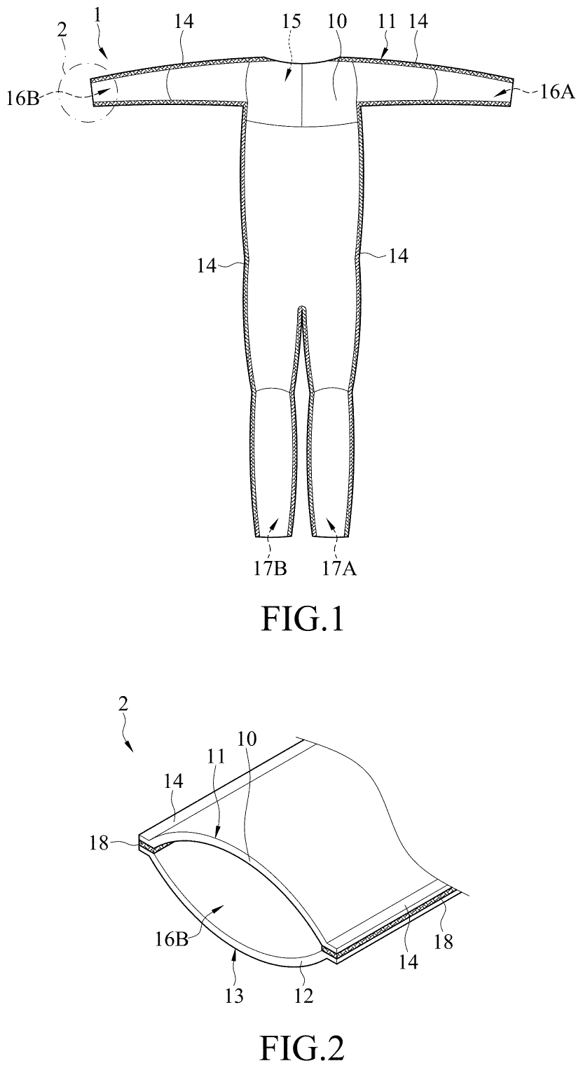

Please refer to the FIGS. 1 and 2. FIG. 1 is the floor plan of this invention, showing the first preferred embodiment. FIG. 2 is the partially enlarged view of the area 2 from the FIG. 1. As shown in FIGS. 1 and 2, the best example from this invention is the full-body protective coverall 1 (will abbreviate as “coverall”). This coverall contains a front fabric layer 10, which shapes as a front contour 11, and a rear fabric layer 12, which shapes as a back contour 13. Since the front contour 11 and rear back contour 13 have to be assembled to become a complete coverall, the front contour 11 and rear contour 13 are substantially matched.

Coverall 1 contains several joint areas 14, located in the front contour 11 and the rear contour 13. As shown in FIG. 1 and FIG. 2, except for the through-holes of coverall 1 which are associated with the head area 15, hand/arm areas 16A and 16B, foot areas 17A and 17B, the joint areas located correspond to the wearer's trunk, upper limbs, and lower limbs, respectively. As shown in FIG. 2, within the range of the predetermined joint areas 14, an intermediate fabric layer 18 is arranged between the front fabric layer 10 and rear fabric layer 12. Besides, the intermediate fabric layer 18 is intertwined with the front fabric layer 10 and rear fabric layer 12, which construct a three-dimensional structure and a total of three layers herein.

Based on the first preferred embodiment of the instant disclosure, it can be seen that the coverall 1, which the portions of the front fabric layer 10 and the rear fabric layer 12, within the range of joint areas 14, are intertwined with the intermediate fabric layer 18. According to the instant disclosure, it is based on the protective coverall 1 is arranged and planned in advance that the front fabric layer 10 and rear fabric layer 12 are formed according to the front contour 11 and rear contour 13. At the edges of the front contour 11 and rear contour 13, several joint areas 14 can be predetermined and arranged. Moreover, the intermediate fabric layer 18 are knitted with the portions of the front fabric layer 10 and rear fabric layer 12 within range of the joint areas 14 during knitting the front fabric layer 10 and rear fabric layer 12, which construct a three-dimensional structure, and finally cut out the protective coverall 1 based on the front contour 11 and the rear contour 13.

According to the first preferred embodiment of the instant disclosure, the protective coverall 1 formed integrally can be woven with a warp knitting machine or a weft knitting machine. Preferably, the weaving quality of a circular knitting machine is better. The front fabric layer 10, the back fabric layer 12, the intermediate fabric layer 18, can be made of polyester fibers, nylon fibers, spandex fibers, recycled fibers, biodegradable fibers, and other similar materials. As for the intermediate fabric layer 18, it can be made of monofilament or multifilament fibers. Moreover, to further increase the antibacterial effect, the intermediate fabric layer 18 can be yarns containing silver ions, yarns of zinc oxide, or nano-copper yarns.

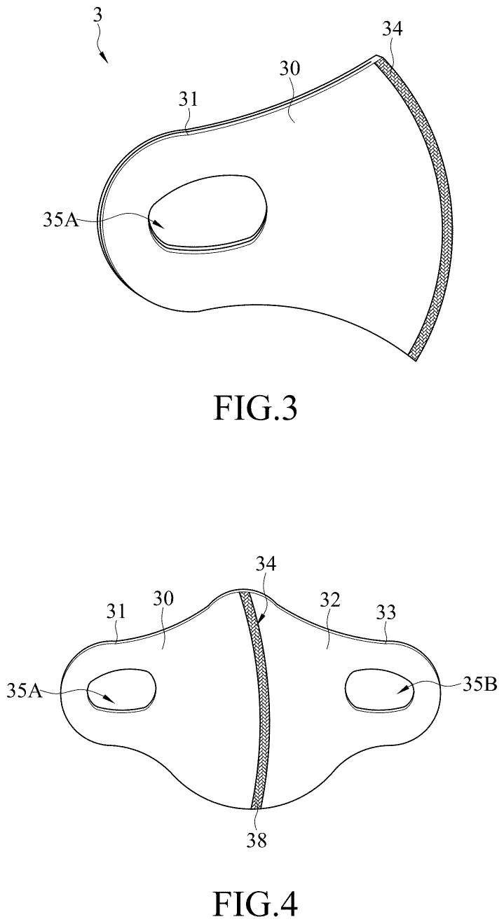

Referring to FIG. 3 and FIG. 4, FIG. 3 is the floor plan of the second preferred embodiment in accordance with the instant disclosure. FIG. 4 is the expanded perspective view of FIG. 3. As shown in FIG. 3 and FIG. 4, the second preferred embodiment is concerned with a mask 3. This mask 3 contains a right half fabric layer 30 and a left half fabric layer 32. The right half fabric layer 30 has a right half contour 31, and the left half fabric layer 32 has a left half contour 33. Since the right half contour 31 and the left half contour 33 need to be combined into a complete mask 3, the right half of contour 31 and the left half contour 33 need to be substantially matched. The reference numerals 35A and 35B indicate ear hook holes.

The mask 3 also includes a predetermined joint area 34, roughly located at the predetermined edges of the right half contour 31 and the left half contour 33. As shown in FIG. 3 and FIG. 4, the predetermined joint area 34 corresponds to the portion covering the wearer's mouth and nose. As shown in FIG. 4, it also includes an intermediate fabric layer 38 disposed between the right half fabric layer 30 and the left half fabric layer 32 within the range of the predetermined joint area 34. It is preferably noted that the intermediate fabric layer 38 is intertwined with the right half fabric layer 30 and the left half fabric layer 32.

Based on the second preferred embodiment of the instant disclosure, it can be seen that the right half fabric layer 30 and the left half fabric layer 32 of the mask 3 are joined by forming a three-layer three-dimensional fabric structure within the range of the predetermined joint area 34. In other words, the three-layer three-dimensional fabric structure is formed by intertwining the intermediate fabric layer 38 with the right half fabric layer 30 and the left half fabric layer 32. According to the specification of the mask 3, it is planned in advance that the right half fabric layer 30 and the left half fabric layer 32 have a right half contour 31 and a left half contour 33, respectively. The predetermined joint area 34 at the edge of the right half shape 31 and the left half shape 33 are determined and arranged in advance in accordance with the instant disclosure. Next, when knitting the right half fabric layer 30 and the left half fabric layer 32, portions of the right half fabric layer 30 and the left half fabric layer 32 are knitted with the intermediate fabric layer 38 within range of the predetermined joint area 34 to form a three-layer three-dimensional fabric structure. The mask 3 can be thereafter tailored and formed based on the right half contour 31 and the left half contour 33.

Based on the instant disclosure's second preferred embodiment, the mask 3 can be manufacture by a warp knitting machine or a weft knitting machine. Preferably, the knitting quality of a circular knitting machine is better. The right half fabric layer 30, the left half fabric layer 32, the intermediate fabric layer 38 can be made of polyester fibers, nylon fibers, spandex fibers, recycled fibers, biodegradable fibers and other similar materials. As for the intermediate fabric layer 38, it can be monofilament or multifilament fibers. The intermediate fabric layer 38 can be yarns containing silver ions, yarns of zinc oxide, or nano-copper yarns to enhance the antibacterial effect.

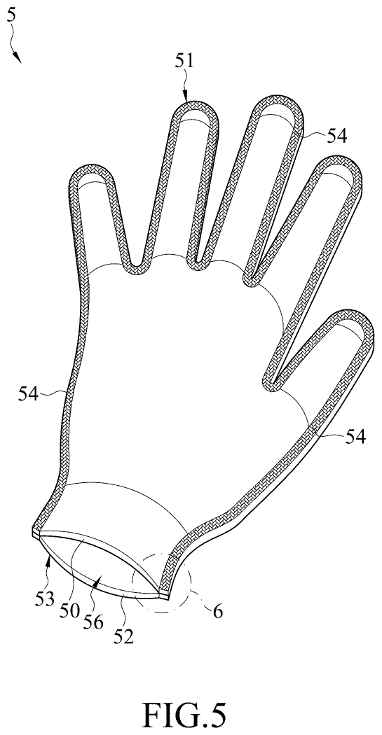

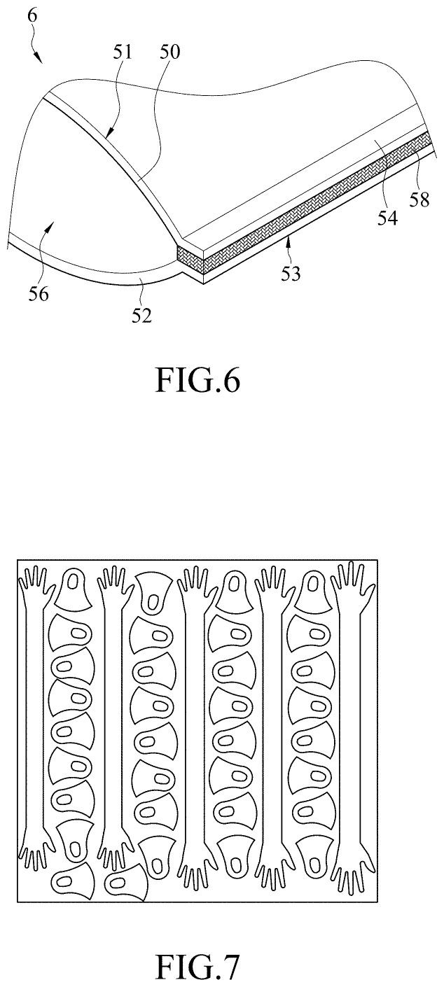

Referring to the FIG. 5 and FIG. 6. FIG. 5 is the floor plan view of the third preferred embodiment in accordance with the instant disclosure. FIG. 6 is the partial view of area 6 enlarged from the FIG. 5. FIG. 5 and FIG. 6 show that the third preferred embodiment is a glove 5, which includes a hand palm fabric layer 50 and a hand back fabric layer 52. The palm fabric layer 50 has a hand palm contour 51, and the hand back fabric layer 52 has a hand back contour 53. Since the hand palm contour 51 and the hand back contour 53 need to be combined and assembled into one glove 5, the hand palm contour 51 and the hand back contour 53 need to be substantially matched.

The glove 5 also includes several predetermined joint areas 54, roughly located at the predetermined edges of the hand palm contour 51 and the back contour 53. As FIG. 5 and FIG. 6 show, except for the through-holes 56 corresponding to the wearer's hand, the predetermined joint area 54 is spread over the five fingers and the wearer's wrist. As shown in FIG. 6, there is an intermediate fabric layer 58 disposed between the hand palm fabric layer 50 and the hand back fabric layer 52, and the intermediate fabric layer 58 is intertwined in-between with the hand palm fabric layer 50 and the hand back fabric layer 52 to form a three-dimensional fabric structure with three layers of fabric respectively in the predetermined joint area 54.

Based on the third embodiment of the present invention, it can be seen that portions of the hand palm fabric layer 50 and the hand back fabric layer 52 of the glove 5 are joined by forming a three-layer three-dimensional fabric structure within the range of the predetermined joint area 54 which the intermediate fabric layer 58 is formed by alternately knitting the hand palm fabric layer 50 and the hand back fabric layer 52. According to the specifications of the glove 5, it is planned and arranged in advance that the hand palm fabric layer 50 and the hand back fabric layer 52 have a hand palm contour 51 and a hand back contour 53, respectively, and preserve a joint area 54 at edges of the hand palm contour 51 and the hand back contour 53 are planned and arranged. Then, when knitting the hand palm fabric layer 50 and the hand back fabric layer 52, the portions of the hand palm fabric layer 50 and the hand back fabric layer 52 are knitted with the intermediate fabric layer 58 within the range of the predetermined joint area 54 to form a three-dimensional fabric structure. The glove 5 would be tailored out according to the hand palm contour 51 and the hand back contour 53.

Based on the instant disclosure's third preferred embodiment, the integrated glove 5 can be manufactured by a warp knitting machine or a weft knitting machine. Preferably the knitting quality of a circular knitting machine is better. The hand palm fabric layer 50, the hand back fabric layer 52, the intermediate fabric layer 58 can be made of polyester fibers, nylon fibers, spandex fibers, recycled fibers, biodegradable fibers and other similar materials. The intermediate fabric layer 58 can be monofilament or multifilament fibers. The intermediate fabric layer 58 can be made of yarns containing silver ions, yarns of zinc oxide, or nano-copper yarns to enhance the antibacterial effect.

Based on the three preferred embodiments as above, the manufacturing method of the integrally formed personal wear of the instant disclosure, the first contour (such as the front contour 11, the right half contour 31, or the hand palm contour 51), and the second contour (such as the back contour 13, the left half contour 33, or the back contour 53). Several predetermined joint areas (such as the areas 14 34, 54, etc.) are planned and arranged at the predetermined edges of the first contour and the second contour at the same time. The processes can be called an arrangement board, which is an example as shown in FIG. 7, only showing the gloves and masks as for illustrative purposes and is not intended to limit the scope of the present invention. The one-piece personal wear can be manufactured by knitting the first fabric layer (such as the front fabric layer 10, the right half fabric layer 30, or the hand palm fabric layer 50), the second fabric layer (such as the back fabric layer 12, left half hand fabric layer 32, or the hand back fabric layer 52), and portions the first fabric layer and the second fabric layer are knitted by intertwining with an intermediate fabric layer (such as 18, 38, 58, etc.) within the range of the predetermined joint areas (such as 14, 34, 54 or the like) to form a three-dimensional structure and finally cut it along the first contour and the second contour.

Therefore, this invention reveals a one-piece three-dimensional structure knitting technology that eliminates the uncomfortable feeling compared to the traditional weaving's joining region. The three-dimensional knitting technology used in the instant disclosure adopts a sandwich fabric structure within the range of the predetermined joint areas of the personal wear. The air permeability of the predetermined joint area by the characteristics of the sandwich fabric to enhance, which makes the finished personal wear softer, more comfortable, more breathable, and water repellent.

What is claimed is:

1. A one-piece personal wear, comprising:
a first fabric layer and a second fabric layer provided with a first contour and a second contour, respectively;
at least one joint area arranged at predetermined edges of the first contour and the second contour; and
an intermediate fabric layer locally provided to intertwine with the first fabric layer and the second fabric layer within the joint area to form a three-layer fabric structure.

2. The one-piece personal wear according to claim 1, wherein the first contour and the second contour are matched with each other.

3. The one-piece personal wear according to claim 1, wherein the intermediate fabric layer is made of anti-bacteria material.

4. The one-piece personal wear according to claim 3, wherein the intermediate fabric layer includes yarns of silver ions.

5. The one-piece personal wear according to claim 3, wherein the intermediate fabric layer includes yarns of zinc oxides.

6. The one-piece personal wear according to claim 3, wherein the intermediate fabric layer includes yarns of nano-copper.

7. The one-piece personal wear according to claim 1, wherein the intermediate fabric layer includes monofilaments or multiple filaments.

8. A method for fabricating a one-piece personal wear, comprising the following steps of:
forming a first fabric layer and a second fabric layer provided with a first contour and a second contour, respectively, in accordance with a specification of the one-piece personal wear;
forming at least one joint area arranged at predetermined edges of the first contour and the second contour; and
forming an intermediate fabric layer locally intertwining with the first fabric layer and the second fabric layer within the at least one joint area to form a three-layer fabric structure.

9. The method for fabricating the one-piece personal wear according to claim 8, wherein the first contour and the second contour are matched with each other.

10. The method for fabricating the one-piece personal wear according to claim 8, wherein the intermediate fabric layer is made of anti-bacteria material.

11. The method for fabricating the one-piece personal wear according to claim 10, wherein the intermediate fabric layer includes yarns of silver ions.

12. The method for fabricating the one-piece personal wear according to claim 10, wherein the intermediate fabric layer includes yarns of zinc oxides.

13. The method for fabricating the one-piece personal wear according to claim 10, wherein the intermediate fabric layer includes yarns of nano-copper.

14. The method for fabricating the one-piece personal wear according to claim 8, wherein the intermediate fabric layer includes monofilaments or multiple filaments.
